(19) United States
(12) Patent Application Publication
(10) Pub. No.: US 2008/0029922 A1
(43) Pub. Date: Feb. 7, 2008

(54) POLYMER MOLDING SYSTEM AND METHOD OF OPERATION FOR PRODUCING AN ARTICLE OF MANUFACTURE

(75) Inventors: Kevin Keen, Marshall, MI (US); Helmut F. Homann, Marshall, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: Tapco International Corporation, Wixom, MI (US)

(21) Appl. No.: 11/750,094

(22) Filed: May 17, 2007

Related U.S. Application Data
(60) Provisional application No. 60/747,578, filed on May 18, 2006.

(51) Int. Cl. B29C 47/04

(52) U.S. Cl. 264/75; 425/112; 425/116

(57) ABSTRACT

A polymer molding system and method of operation produces synthetic article of manufacture that simulate natural building materials such as wooden shakes and stone roofing tiles. The system preferably feeds at least two dye compounds and a polymer filler material into an extruder for heating into a ribbon. The ribbon is heated as it travels through the extruder and through an outlet end where a slicing unit cuts the ribbon into a plurality of preforms at a pre-defined rate. Because the dye compounds are not homogeneously mixed with one another, the ribbon and hence the preforms are generally of at least two colors. Each preform is individually fed into a press that stamps and partially cools the preform into the simulated article of manufacture shape that also accentuates the varying colors. Preferably, the stamped article is then flexed or cupped between a carriage and a dead weight prior to crystallization and where it then cools and crystallizes to a final shape. This cupped shape of the article of manufacture is generally straightened out under stress when the article is installed.

### CROSS-REFERENCE TO RELATED APPLICATION

The instant application claims priority to U.S. Provisional Patent Application Ser. No. 60/747,578, filed May 18, 2006, the entire specification of which is expressly incorporated herein by reference.

### FIELD OF THE INVENTION

The present invention relates generally to a polymer molding system and more particularly to a plastic extruding and stamping system for producing a synthetic article of manufacture that simulates building products made of naturally occurring materials.

### BACKGROUND OF THE INVENTION

Natural slate and cedar have long been common roofing materials because of their ability to protect the underlying structure from the weather while appearing aesthetically pleasing. Unfortunately, slate or any stone is relatively heavy and expensive to manufacture and install. Due to the weight of stone, special preparations must also be done to support the additional weight when compared to conventional construction. Yet further, stone or slate is known to be brittle and therefore cannot withstand appreciable amounts of weight when lying upon the roof. Maintenance of slate roofs or replacement of broken tiles or shingles is therefore known to be cumbersome and expensive. In regards to the use of wood or cedar as shingles, such material is not naturally resistant to fire and like stone, is time consuming and expensive to install.

As an alternative material, shingles made generally of plastic and manufactured in an attempt to resemble stone or wood are known in the industry. Two such shingles are taught in U.S. Pat. No. 6,025,052, issued Jul. 15, 2000 and U.S. Pat. No. 4,307,552, issued Dec. 29, 1981, both being incorporated herein by reference in their entirety. Unfortunately, known simulated shingles are uniform in color (i.e. dark grey) and a single shingle does not very in color as the naturally occurring stone or wood would, thus it's authenticity from a casual observer is placed in question. Moreover, known molds of a press are machined in an attempt give the finished product the dimensional appearance of slate or cedar. Unfortunately, this appearance is still very different than the detail of the naturally occurring material.

The manufacturing process of these simulated natural occurring shingles or any other similar articles of manufacture utilizing plastic as the material, typically delivers a pellet form of the plastic to an extruder that then heats the plastic into a pliable form. Prescribed quantities of the heated plastic is placed in a press for shaping of the shingle in a planar form. Unfortunately, the finished, planar, product is relatively stiff and any inconsistencies or variances in the roof underlayment can lead to a shingle that does not lye flat to the roof (i.e. the exposed leading edge of the shingle is spaced from the underlying shingle). Yet further, some plastic tiles may warp under the harsh exposure and heat from lying upon a roof. This exposure could cause the leading edge of the tile to warp and lift away from the underlying tile causing an unwanted “ruffled-feather” appearance.

Moreover, known presses typically have hydraulic rams that push down from above, thus moving an upper platen carrying the first half of a mold against a stationary lower platen carrying the second half of the mold. Should the hydraulic ram fail, it is plausible that the press fails in a compressed position in part due to gravitational forces making repairs more difficult and leading to safety concerns.

### SUMMARY OF THE INVENTION

A polymer molding system and method of operation produces synthetic article of manufacture that simulate natural building materials such as wooden shakes and stone roofing tiles. The system preferably feeds at least two dye compounds and a polymer filling material into an extruder for heating into a ribbon. The ribbon is heated as it travels through the extruder and through an outlet end where a slicing unit cuts the ribbon into a plurality of preforms at a predefined rate. Because the dye compounds are not homogeneously mixed with one another, the ribbon and hence the preforms are generally of at least two distinct colors. Each preform is individually fed into a press that stamps and partially cools the preform into the simulated article of manufacture shape that also accentuates the varying colors. Preferably, the stamped article is then flexed or cupped between a carriage and a dead weight prior to crystallization and where it then cools and crystallizes to a final shape. This cupped shape of the article of manufacture is generally straightened out under stress when the article is installed.

Preferably, the article of manufacture is a roofing tile that resembles in color, shape and texture a stone tile such as slate. The press has a stationary first platen and a moving second platen that preferably moves vertically from a lower open position and upward to a pressed or closed position. Both platens preferably carry cooling channels for partially cooling the article of manufacture. A mold of the press has a first half portion carried by the first platen and a second half portion carried by the second platen. The second half portion is preferable cast from a building material (e.g. slate tile) to enhance authenticity and appearance.

Objects, features and advantages of this invention include a system that produces economical, light weight and easy to install articles of manufacture that closely simulate natural building materials such as stone roofing tiles and wooden shakes. Other advantages include a process that produces an improved synthetic roofing tile that resists warpage as a result of exposure to harsh environmental conditions and a system that enhances safety, is robust, relatively simple in design and durable.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic of a polymer molding system of the present invention;

FIG. 2 is a perspective end view of an extruder of the polymer molding system;

FIG. 3 is a perspective view of a press in an open position of the polymer molding system;

FIG. 4 is a perspective view of the press in a closed position;

FIG. 5 a perspective view of a carriage of the polymer molding system;

FIG. 6 is a top view of an article of manufacture produced by the polymer molding system;

FIG. 7 is a side view of the article of manufacture; and

FIG. 8 is a cross section of the article of manufacture taken from line 8-8 of FIG. 6.

### DETAILED DESCRIPTION OF THE PREFERRED EMBODIMENT

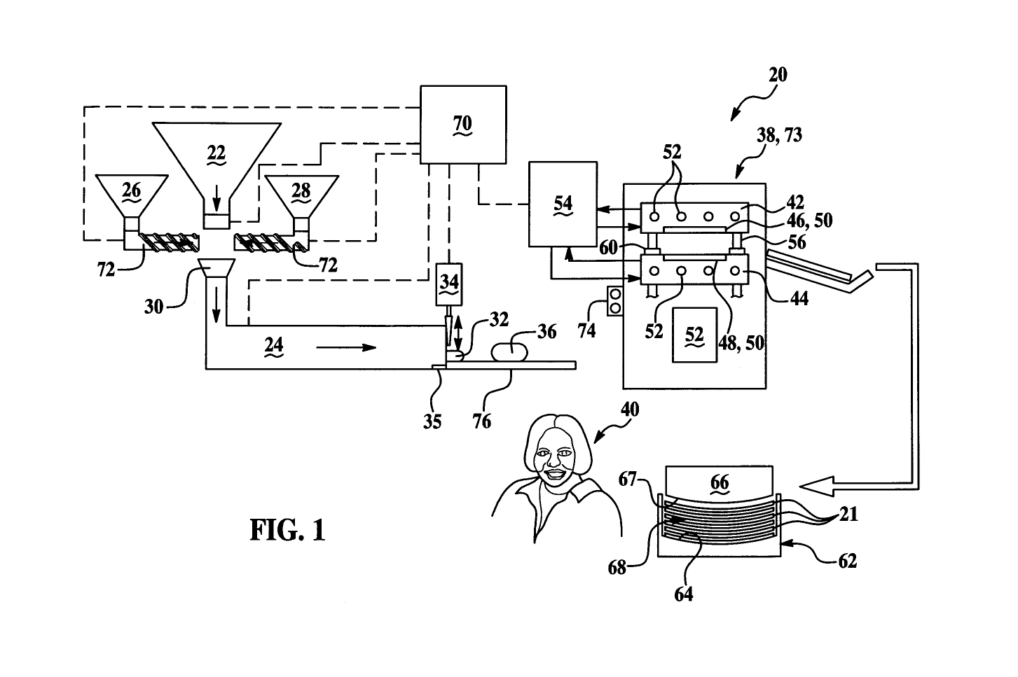

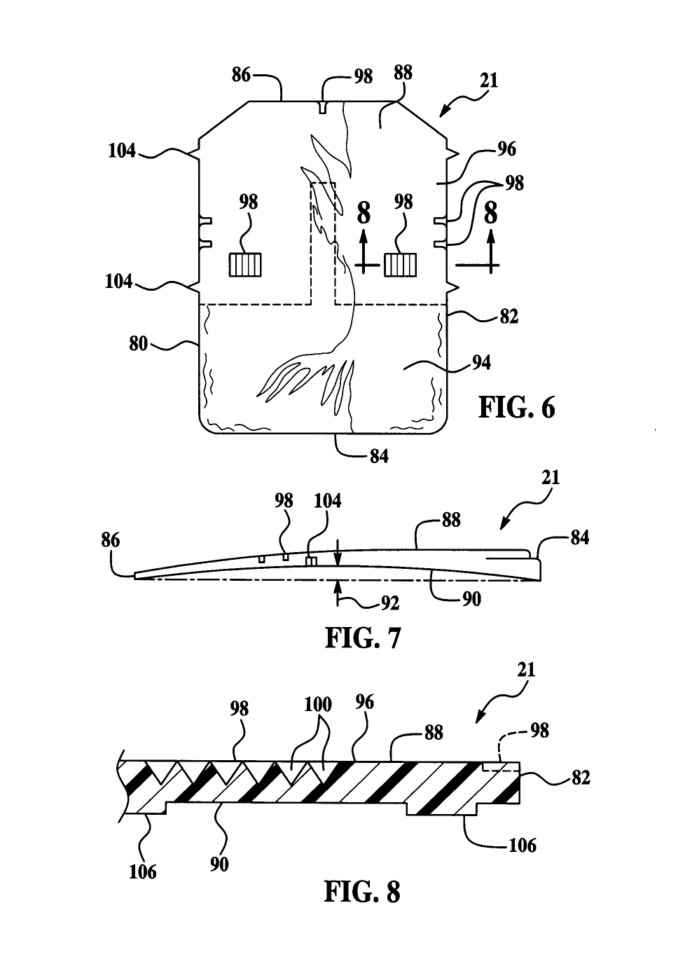

Referring to FIGS. 1 and 6, a polymer molding system 20 and method for the continuous extrusion and stamping of a polymeric material, of the present invention, produces a generally synthetic article of manufacture 21. The article of manufacture 21 is preferably a roofing shingle or tile made of a polymer such as plastic and designed to simulate natural stone both in color variations, shape and texture. This simulated stone is preferably slate that is commonly used for roofing tile. Another natural building material commonly used on roofs and exterior walls are wooden or cedar shakes which may also be generally copied via the system 20 and as the article of manufacture 21 of the present invention.

The system 20 preferably has a first or main hopper 22 that feeds pellets of a polymeric, filler, material into an inlet end 30 of a stationary extruder 24 at a prescribed rate. Preferably, the inlet end 30 is a gravity fed receiving chute that receives the pellets from above. Also fed into the chute 30 of the extruder 24 at a prescribed rate and/or periodic frequency is at least one dye compound. As illustrated, the system 20 preferably has a first dye hopper 26 and a second dye hopper 28 that feeds selected dye compounds into the receiving chute 30 of the extruder 24 preferably located below. Because the dye compounds are generally not mixed homogenously with one-another, the resulting article of manufacture 21 displays a novel plurality of distinctive colors.

The compounded polymeric material and dye compounds flowing controllably through the extruder 24 are heated to generally melt the raw pellets, or filler, and form a ribbon 32 of polymeric material having a desired cross sectional shape. The elongated ribbon 32 is substantially linear and horizontal. Discrete lengths of extruded material are cut from the continuously formed ribbon 32 by a slicing unit 34 and as the heated ribbon 32 exits an outlet end 35 of the extruder 24 (see FIGS. 1 and 2). Each cut length of the ribbon 32 forms a preform 36 having a prescribed volume and density preferably for the formation of the article of manufacture or roofing tile 21. See U.S. Pat. No. 5,266,246, issued Nov. 30, 1993 and incorporated herein by reference in it's entirety.

The system 20, has at least one and preferably a plurality of presses 38 that operate preferably asynchronously to one another for manufacturing efficiency. Each press 38 is preferably manually fed a preform 36 by an operator 40 and while the preform 36 is still in a heated and pliable state. One skilled in the art, however, would now know that feeding of the preforms 36 could also be done by an automated transport.

Referring to FIGS. 1 and 3-4, the press 38 has a stationary upper platen 42 and a substantially vertically movable bottom platen 44. Each platen 42, 44 carries a respective half portion 46, 48 of a mold 50. At least one of the two half portions 46, 48 of the mold 50 is cast (as opposed to machined) to substantially form the shape and texture of the naturally occurring material (i.e. slate shingle/tile or cedar shake) being simulated. The bottom platen 44 connects to a hydraulic ram unit 52 that moves the bottom platen 44 and mold half portion 48 upward toward the half portion 46 of the mold 50.

Both platens 42, 44 of the press 38 carry cooling fluid channels 53 that preferably flow chilled water controlled via a cooling control unit 54. By cooling the platens 42, 44, the platens, in turn, partially and controllably cool the preform 36 and/or article of manufacture 21 during the hydraulic press procedure. Preferably, projecting downward from each corner of the upper platen 42 is a cylindrical guide 56 that extends through holes in the bottom platen 44. Located generally in the holes and concentrically about each guide 56 is a ball bearing carrying sleeve 60 that reduces frictional forces placed upon the ram unit 52.

In operation of the system 20, a controller 70 controls the volumetric rate of filler material and dye compounds exiting the hoppers 22, 26, 28 preferably at least in-part through electric screw delivery units 72 of the hoppers (see FIG. 1). In this way, the controller 70 controls the color distribution of the final product and matches the resultant volumetric flow with the processing rate of the extruder 24 (i.e. heat up rate and ribbon travel rate). Preferably, knowing the ribbon 32 travel rate, the controller also controls the reciprocating action of the slicing unit 34.

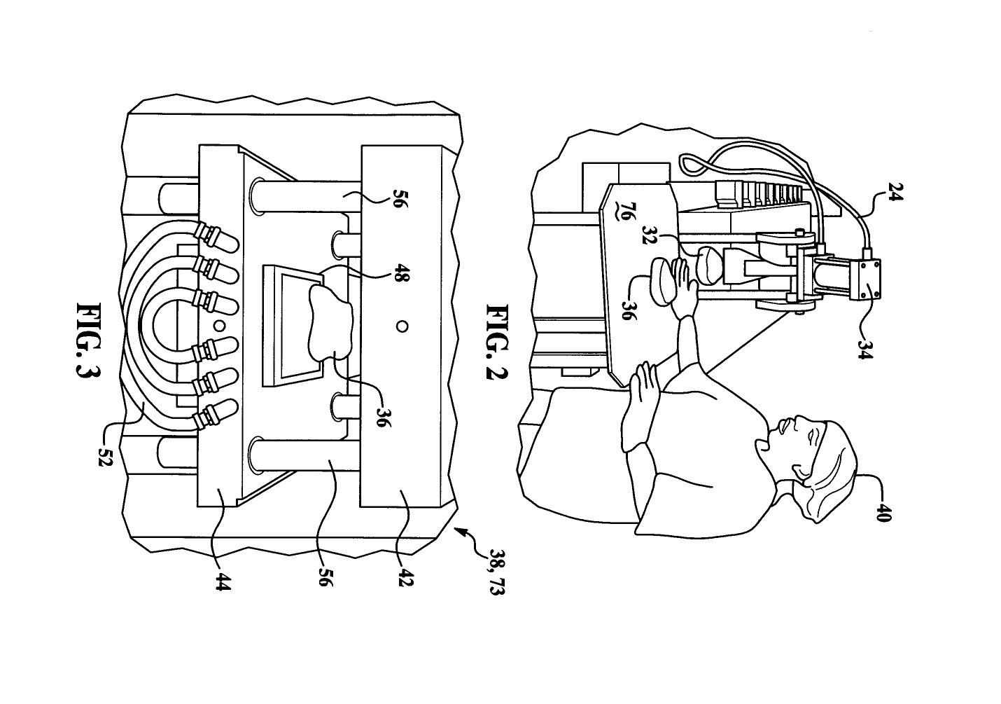

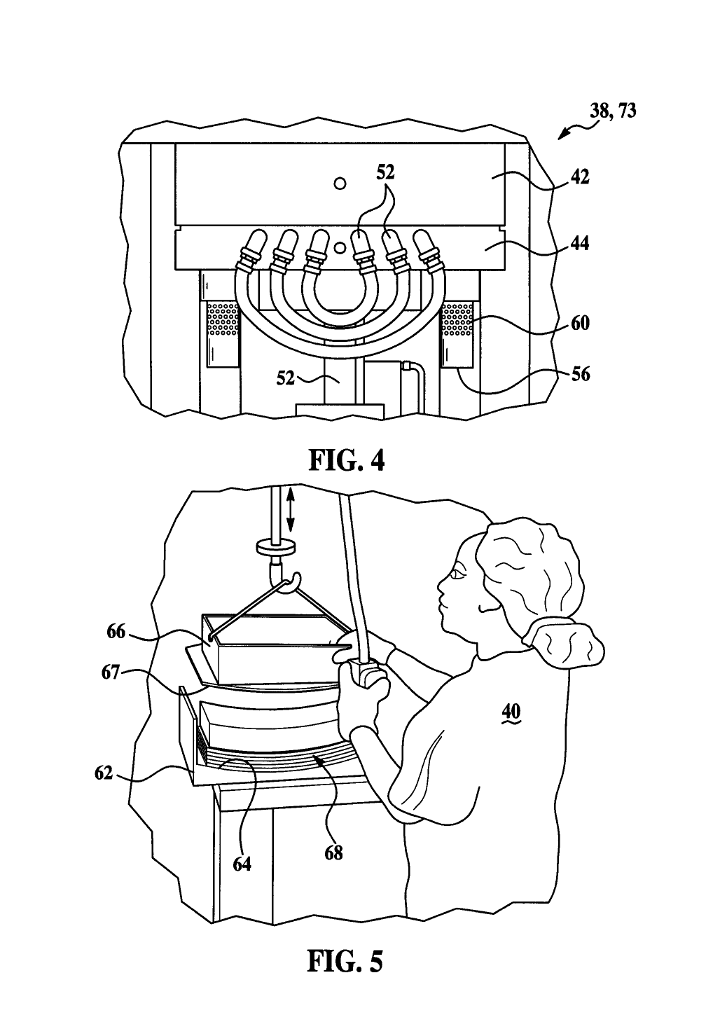

When cut, the operator 40 places the heated preform 36 on top of the half portion 48 of the mold 50 while the press 38 is in an open position 73 (see FIGS. 2-3). The operator 40 then selects an actuator or button 74 to begin the press process. Preferably, while the first press 38 is hydraulically moving upward toward the compressed position 75 (see FIG. 4), the operator grabs a second preform 36 from the extruder 24 and is placing it into a second press 38, thus the first and second presses 38 operate asynchronously.

Preferably, the controller 70 controls the temperature of the exiting ribbon 32 to about 400 degrees Fahrenheit and/or preferably within a range of 390 to 410 degrees Fahrenheit. This temperature is generally dependent upon the composition of the filler material of the ribbon 36 and is generally that temperature required to maintain pliability of the preform 36 for the pressing process, while still having a rigid enough consistency to be handled by the operator 40 when moved from an extruder tray 76 to the press 38.

The controller 70 also controls the temperature of the platens 42, 44 and thus the preformed article of manufacture or tile 21 through the control unit 54. The preferred exiting temperature of the tile 21 is about 180 degrees Fahrenheit and/or preferably within the range of 160 to 200 degrees Fahrenheit. This temperature is also dependent upon the material. Ideally, the temperature is not so high that the tile deforms upon handling, but is high enough that the tile 21 has yet to crystallize and thus can still be altered in shape while cooling by the external exertion of a force or dead weight 66.

For the sake of illustration and example, if the article of manufacture 21 is a simulated/synthetic roofing tile, after exiting the press 38 the partially cooled tile 21 is substantially planar. Prior to full cooling of the tile 21 and thus crystallization of the polymeric material, the tile 21 is cupped or slightly bent utilizing a carriage 62. The partially cooled tile 21 is stacked in the carriage 62 with other tiles preferably upon a concave bottom 64 of the carriage (see FIGS. 1 and 5). With a plurality of cooling tiles 21 stacked in the carriage 62 the dead weight 66 having a convex bottom face 67 is placed on top of the stacked tiles 21. Because the convex bottom face 67 substantially conforms in shape to the concave bottom 64 each tile 21 crystallizes as they cool with a substantially consistent radius of curvature.

Once cooled to room temperature, the curved tile is relatively stiff. When installing on a roof, the cup of the tile 21 is placed face down. This cupping effect alleviates any inconsistencies or variances in the roof underlayment that could otherwise lead to an unwanted finished appearance where the tiles do not lie flat. Moreover, because polymeric tiles may warp (i.e. leading tile edges lifting up and away from the underlying tile) under the harsh exposure and heat from lying upon a roof, the cupped tiles 21 are preferably under stress when installed. This stress counters any affects that could otherwise lead to unsightly warpage by producing a force upon the underlying tile by the leading edge of the overlying tile.

Referring to FIGS. 6-8 and more specific to the tile 21, the tile is preferably made of polypropylene type WPP221-Natural Co-Polymer 2.0-6.0 Melt, 1.0-2.5 Izod. The compound type is preferably PPC1FR&-Natural 0.25-3.5 Melt Flow, Filler Content 47.0-53.0. Color may vary depending upon the final product demands. Each tile 21 has longitudinal first and second edges 80, 82 that a are substantially parallel to one another, a lower edge 84 and an upper edge 86. The tile 21 has a top surface 88 and an opposite bottom surface 90.

In one example of a slate simulated tile 21, the tile is about eighteen inches long and eleven and a half inches wide, or in other words, the longitudinal first and second edges 80, 82 are about eighteen inches long and the lower edge 84 is about eleven and a half inches wide. The top and bottom surfaces 88, 90 taper toward one-another as they extend from the lower edge 84 to the upper edge 86. Preferably, the lower edge 84 is about one-quarter inches wide or thick and the upper edge 86 is about one-eighth inches wide or thick. When the tile 21 is fully cooled and prior to installation on the roof, the top surface 88 carries a convex contour as it spans between the edges 84, 86. Similarly, the bottom surface 90 has a concave contour as it spans between the edges 84, 86. For a typical roof application where the tile 21 is approximately eighteen inches long, the contour forms a camber (designated by arrow 92) of about 1.25 inches and/or within a range of 1.00 to 1.50 inches. Alternatively, the ratio between the camber 92 and the length of the tile 21 is about six to eight percent.

The top surface 88 has a reveal portion 94 that extends between side edges 80, 82 and spans from the lower edge 84 to about thirty-five to fifty percent the length of the tile 21 (e.g. for a tile that is eighteen inches long, the reveal portion generally extends about 7.5 inches from the lower edge 84). The top surface 88 also has a covered portion 96 that spans the remainder of the top surface 88, from the reveal portion 94 generally to the upper edge 86.

Preferably, the top surface 88 is formed by the bottom half portion 48 of the mold 50. Because the half portion 48 is cast, the reveal portion 94 of the top surface 88 can closely simulate the surface roughness and/or texture of authentic slate. This texture includes chamfered edges common in natural slate. The mold 50 may also create other features in the covered portion 96 including two fastener or nail indentations or pads 98 each having a plurality of grooves 100 that generally decrease the thickness of the tile 21 at the indentations 98 for improving the tile installation process. The covered portion 96 may also carry a plurality of indexing recesses 102 and indexing spacers 104 at each side edge 80, 82 for appropriate spacing of the tiles from one another when installed on a roof.

Preferably, the concave bottom surface 90 of the tile 21 has a plurality of ribs 106 that promote strength of the tile 21 while reducing the volume of material required to form the tile 21. The ribs 106 preferably extend longitudinally between the lower and upper edges 84, 86.

When the tile is installed, the nails projecting through the nailing pads 98 of the tile 21 generally flatten the tiles out upon the roof so that the camber range is substantially reduced to zero while the resiliency of the crystallized tile caused the revealed edge 84 to generally exert a downward force upon the underlying tile due to the resiliency of the overlying tile. This biasing force counters any tendency of a tile or shingle from warming upward because of harsh weather environment.

Although the preferred embodiment of the present invention has been disclosed, various changes and modifications may be made thereto by one skilled in the art without departing from the scope and spirit of the invention as set forth in the appended claims. It is also understood that the terms used herein are merely descriptive, rather than limiting, and that various changes may be made without departing from the scope and spirit of the invention.

1. A polymer molding system for producing synthetic articles of manufacture, the polymer molding system comprising:
an extruder for forming and heating a ribbon of polymeric material, the extruder having an inlet end and an outlet end;
a first dye hopper for feeding a first dye compound into the extruder;
a second dye hopper for feeding a second dye compound into the extruder with restricted mixing with the first dye compound;
a slicing unit oriented at the outlet end for cutting the ribbon into a plurality of preforms;
a press constructed and arranged to receive at least one of the plurality of preforms for molding into the article of manufacture.

2. The polymer molding system set forth in claim 1 wherein the article of manufacture is a roofing tile having stone appearance.

3. The polymer molding system set forth in claim 1 wherein the article of manufacture is a wall shake having a wood appearance.

4. The polymer molding system set forth in claim 1 further comprising a main hopper for feeding pellets of the polymeric material into the inlet end.

5. The polymer molding system set forth in claim 1 further comprising a controller for electrically controlling the rate of travel of the ribbon through the extruder and the rate of slicing of the slicing unit.

6. The polymer molding system set forth in claim 5 wherein the controller electrically controls the temperature of the ribbon.

7. The polymer molding system set forth in claim 1 further comprising a mold having a first half for detailing a bottom surface of the article of manufacture, and a top half for detailing a top surface of the article of manufacture that simulates the texture of a roofing tile made of natural stone.

8. The polymer molding system set forth in claim 7 wherein the top half is at least in part a casting of the roofing tile made from natural stone.

9. The polymer molding system set forth in claim 7 further comprising:
first and second platens of the press that respectively carry the first and second halves of the mold; and
a cooling channel in at least one of the first and second platens for reducing the temperature of the article of manufacture when being pressed.

10. The polymer molding system set forth in claim 9 further comprising:
a carriage having an arcuate bottom facing upward;
a dead weight having an arcuate bottom face that faces downward and conforms in shape to the arcuate bottom; and
wherein at least one of the plurality of the articles of manufacture are stacked upon the arcuate bottom and beneath the arcuate bottom face after being pressed and prior to cooling to a polymer crystallizing temperature.

11. A method of operating a polymer molding system for manufacturing a synthetic roofing tile comprising the steps of:
feeding a polymer filler material into an inlet end of an extruder;
feeding first and second dye compounds without homogeneous mixing into the inlet end simultaneously to feeding the polymer filler material;
heating the filler material and first and second dye compounds by the extruder;
forming a ribbon from the mixture;
transporting the ribbon through an outlet end of the extruder at a controlled rate of speed;
cutting the ribbon into preforms by a slicing unit having an actuation frequency dependent upon the rate of speed and a pre-established size of the preforms;
feeding the preforms individually into a press; and
pressing the preforms into the synthetic roofing tile by the press.

12. The method of operating the polymer molding system set forth in claim 11 comprising the further step of controllably heating the ribbon to a pre-established temperature by an electric controller.

13. The method of operating the polymer molding system set forth in claim 12 comprising the further step of cooling the preform during pressing by a plurality of fluid cooling channels for flow controlled by the controller.

14. The method of operating the polymer molding system set forth in claim 13 comprising the further step of removing the synthetic roofing tile from the press while the tile temperature is above a crystallizing temperature.

15. The method of operating the polymer molding system set forth in claim 14 comprising the further step of placing the roofing tile directly between an arcuate bottom of a carriage and a conforming arcuate bottom face for cupping a bottom surface of the roofing tile.

16. The method of operating the polymer molding system set forth in claim 15 comprising the further step of cooling and crystallizing the roofing tile when located between the arcuate bottom and the arcuate bottom face.

17. A polymer molding system for producing synthetic articles of manufacture, the polymer molding system comprising:
a press having a stationary first platen and an opposing second platen constructed and arranged to move toward and away from the first platen;
a mold having a first half carried by the first platen and a second half carried by the second platen;
a cooling control unit for controllably flowing fluid through channels in the first and second platens;
a carriage having a concave bottom;
a dead weight having a convex bottom face opposing the concave bottom; and
wherein a plurality of the articles of manufacture are stacked between the concave bottom and the convex bottom face at pre-crystallizing temperatures for cooling.

18. The polymer molding system set forth in claim 17 wherein the second platen is located beneath the first platen.

19. The polymer molding system set forth in claim 18 comprising a plurality of cylindrical guides projecting downward from the first platen and projecting through ball bearing sleeves supported by the second platen.

20. The polymer molding system set forth in claim 19 comprising a hydraulic ram unit connected to the second platen and for moving the second platen vertically.

21. The polymer molding system set forth in claim 20 wherein the second platen is located beneath the first platen.
